(19) United States
(12) Patent Application Publication
(10) Pub. No.: US 2011/0185672 A1
(43) Pub. Date: Aug. 4, 2011

(54) Block Moulds and Method

(75) Inventor: Kerry Bennett, New South Wales (AU)

(73) Assignee: Benex Techologies Pty Ltd., Orange NSW (AU)

(21) Appl. No.: 13/060,310

(22) PCT Filed: Aug. 31, 2009
(86) PCT No.: PCT/AU09/01129

§ 371 Date: Apr. 22, 2011

(30) Foreign Application Priority Data
Aug. 29, 2008 (AU) 2008904457

(51) Int. Cl. E04C 1/00; B29C 39/36

(52) U.S. Cl. 52/596; 264/334

(57) ABSTRACT

A moulding method for gravity casting masonry blocks which uses a mould with a base and four swing down sides, allows for an outer layer to be cast of different density material and allows for a core to be used to mould hollow blocks. The base and four sides when lowered present an uppermost surface for efficient cleaning.

### FIELD OF THE INVENTION

This invention relates to block moulds, a method of moulding as well as blocks the result of the method.

The term “block” is used throughout but it is intended that this term should be inclusive of bricks.

### DESCRIPTION OF THE PRIOR ART

This invention relates to moulding of concrete blocks using gravity casting which involves wet casting of these which is to be distinguished from a method of manufacture of, concrete blocks conventionally referred to as “besser blocks”. The Besser block starts with a relatively dry mix which is compacted and often vibrated in a mould then very rapidly ejected or extruded from the mould in a matter Of less than a minute or so. The compaction and vibration of such a dry mixture has been able to establish very quickly indeed, a self supporting structure which can then be, independently of the mould, transferred to a further location to be allowed to set and cure. This is contrasted with “wet casting” where the concrete block will remain in the mould for a period of hours before it is self supporting and can be extracted from the mould.

It is also distinguished from autoclaved aerated concrete where a slurry is poured into a mould where it expands but is then remove from the mould after a short period and once expanded and before it is cured is cured in an autoclave for some 12 hours or so.

The dry cast system is widely used because a single mould can be used many repeated times in a short period which means that for a manufacturing installation the cost of many moulds is not so high.

However we have found that there is advantage in using a wet cast moulding method but there are significant difficulties that arise in order to assist in using such a method and resulting blocks from the method so that it might be economically feasible.

In one instance, I have proposed using embedded plastic foam. This is known but it creates a problem where concrete interspersed with plastic foam pellets are visible on an external surface of the block.

I have proposed that there can be an outer surface layer effected of a different material or density of material from a core material which is moulded as a part of the block which can be used as a decorative or otherwise finished outer surface at least for some of the outer surfaces. This also then reduces the costs of using such a block where it may not then afterwards need to be rendered.

I have also established that there is value in having interlocking shapes that provide for improved efficiency when being erected but which also require consistent accurate resulting product.

I have established that there is advantage in having a block moulded from material where it is not appropriate and not in fact feasible to use a dry compression process as in the “besser block” approach but the difficulty then arises as to how to effect manufacture of such a “wet cast” block in a way which facilitates manufacture but allows for automatic production line techniques including facilitating preparation of a mould, eventual stripping of a cast and cured-product from the mould and facilitating subsequent cleaning and further preparation for the next moulding step.

### SUMMARY OF THE INVENTION

The invention could be said to reside in a method of manufacture of a “wet cast” block using a mould, the mould having a rectangular base, and four side walls, each wall secured to a respective end or side of the base so that each wall can, in one case, be positioned in a moulding position where each side wall is held together with the other side walls to define, with the base, a moulding shape, and in a further position, be in a mould block release position, where each respective side wall is swung outwardly from the moulding position, the method of manufacture including the steps of positioning the space in a mould defining position, filling the mould with a to be cast wet cement material, allowing the said material to cure while in the mould, then changing the relative position of the respective sides to a mould release position and thereafter removing the moulded block therefrom.

In preference, each of the respective side walls is each secured to the base by being hingedly coupled thereto.

In preference, the mould when in a mould defining position has an open top into which the material to be cast is poured.

In preference, the block or brick is a hollow block and the method includes the steps of inserting through one of the side walls, a core or plug which is positioned after the side walls are located in a mould defining position, and is held between a first side wall and an oppositely positioned second side wall, the method including the further step of removing the core or plug by extracting this from a side wall after the material has set and only thereafter moving the side walls to a mould release position and effecting removal of the moulded block.

In preference, in a further form the invention could be said to reside in a method of manufacture of a “wet cast block” having at least one face layer which is of a material different to most of the material from which the block is made using the mould, the mould having a rectangular base, and four side walls, each wall secured to a respective end or side of the base so that each can, in one case, be positioned in a moulding position where each side wall is held together with other side walls defining, with the base, a moulding shape, and in a further position, being in a moulded block release position each respective side wall is swung outwardly from the moulding position, the method of manufacture including the steps of positioning the side walls and base in a mould defining position, inserting through one of the side walls, a core which is either one member being bifurcate providing a gap midway between the respective core portions or being two separate cores or plugs which leaves a gap in the mould therebetween, which core or plug or plugs is or are positioned after the side walls are located in a mould defining position and is or are held between a first side wall and an oppositely positioned second side wall, filling the mould with a to be cast wet cement material, allowing the said material to set, removing the core or cores or plug or plugs by extracting this or them from a side wall after the material has set, then changing the relative position of the respective side walls to a mould release position and thereafter removing the moulded block therefrom.

In preference, the material to be cast includes a core of Portland cement, and foam plastics beads.

A typical mixture uses expanded polystyrene beads.

One of the issues with using polystyrene however is that an external surface having such foam beads will display surface interruptions unless a further outer layer is applied to the block.

The method described thus far has significant advantage where a core material includes a significant percentage of foamed plastic material and therefore an external face which can provide a continuous surface in the sense that its surface will not be interrupted by plastic foam beads is considered economically and visually very advantageous.

The method of manufacture therefore includes the step of effecting a coating on the inside of at least some of the side walls and/or base of a first material prior to the introduction of the core material where this includes expanded foam beads.

In another alternative arrangement, such a method of manufacture could also apply where a core material is aerated and where it would otherwise be expected that such air bubbles would be visibly discernible from viewing of the outer surface of a block:

Accordingly, in a further instance, the method of manufacture includes the steps Of applying a first layer to at least some of the side walls and/or the base inner surfaces of a mould as above identified prior to introduction of the core material.

It is implicit in these examples that there would be the normal processes involved in ensuring that any mould defining surface is provided with a release effecting coating, either in the form of an applied release material that is applied prior to its being used for moulding or the surface of the defining shape surfaces are a non stick material.

One of the difficulties with moulding incorporating layers, is that it is very difficult in practice to apply to an inside of the respective surfaces a thin coating for instance a slurry of Portland sand and cement so that this will be uniformly coating the block afterward. This can be very relevant to visual appearance where the layer is not to become a structural component with perhaps different expansion characteristics and altering also the effective overall density of a block.

Consistent thinning and indeed removal of some of the layer material has been discovered to occur in practise.

The challenge has been to discover why this has been occurring and how perhaps to solve this.

After substantial investigation it has been found that by selectively applying a layer in the first instance that is thicker in some places than others, this then can be used as a strategy to effect a subsequent more visually uniform appearance without resulting in undue thickness or any resulting layer.

This has been found to be especially effective where a pouring of core material will, depending on the location, effect a capture and shifting of the material during such pouring.

This is the case where the core, material is poured into a center area between the cores or a gap between the core parts so one approach then is to effect a build up of the layer material immediately beneath such a location.

The passage of core material has been that this will then remove or at least reduce the external layer material at least where the major flow of incoming core material occurs.

It is a fair comment that there is some advantage in having an external surface which is relatively uniformly thin and typically might be within the range of 3-5 mm.

In order to facilitate and automate the moulding process, it has been found particularly for manufacture of the so called “hollow block” which includes the use of a bifurcate core or plug or separate cores or plugs, that the prime core material at least is poured into between the core or plug portions or core or plug parts with the expectation then that this will then flow to each side of a middle area of a mould, and then rise at outer ends with finally material swamping across the top of the cores and providing a final almost flush finish on the top.

Accordingly, there is proposed in preference that in the steps of coating the inner surfaces, that there be introduced a thicker coating in the vicinity of the mould where core material is subsequently to be introduced.

It has been found perhaps surprisingly that by simply building up the layer thickness in the first instance where this is to be in line with first introduced wet core material, that this can effectively be spread and/or carried by the flow but which will result in distribution of the external layer material and at the least, a maintenance of a sufficient thickness in the introductory medial area of the base so that this will not then be unduly afterwards denuded.

The general concept of the method of manufacture and the mould appropriate for this is that it will have an open top and that the top then will be finished off appropriately during the moulding process.

In other words, it is expected that we are talking always about gravity moulding and we have an open side uppermost.

In line with the earlier description, there is significant advantage in providing also a layer on this uppermost surface again so as to reduce or hopefully remove discontinuities in the external visual surface which is therefore more practical or at least visually preferred.

One of the problems however is that in practice it has been found that by simply applying a Portland cement slurry, that subsequent settling results in core material particularly where this includes polystyrene beads, that such styrene beads if styrene is the expanded material being used, rises through the Portland cement or other appropriate matrix to reduce or indeed remove the effectiveness of having an external layer.

A discovery, has been made which is that by changing the density of a Portland cement or a decorative material during its wet state to have this less than the density of the Portland cement constituting the matrix of the core material, this effect can be avoided.

What is proposed and it has been discovered works in this context is that a layer material can be made a material where the density is less than any immediately underlying wet matrix.

If the material is made from a Portland cement aggregate mixture then the aggregate at least is a fine material selected from a material which has a lesser density than the aggregate used for the Portland cement in the main core material.

In practice this can be selected from a variety of materials but scoria is one example so that Portland cement mixed with scoria as a slurry and then using this as a surface layer on the other side of a mould has been found to either sufficiently reduce or remove the effect of concern.

The invention can also reside in a mould including or comprising a base and four side walls, each of which side walls is adjustably positioned one with respect to the other and the base and which can be raised to define a block defining shape or can be released to present its moulding surfaces uppermost for mould release and for subsequent cleaning and coating purposes.

In a further form, the invention can be said to reside in a block or brick resulting from the method as described or as a result of the use of the mould.

### BRIEF DESCRIPTION OF THE DRAWINGS

For better understanding of this invention it will now be described in relation to embodiments which shall be described with the assistance of drawings wherein;

FIG. 1 is a perspective, view of a mould according to the embodiment showing the side walls in a moulded block release position where each respective side wall is swung outwardly from a moulding position,

FIG. 2 is again a perspective view of the same embodiment as in FIG. 1 in which the side walls are raised so that the mould is in a moulding position where each side wall is held together with the other side wall to define with the base a moulding shape,

FIG. 3 is a perspective view of the same embodiment as in FIGS. 1 and 2 illustrating in this case the way in which a core or plug is inserted through one of the side walls,

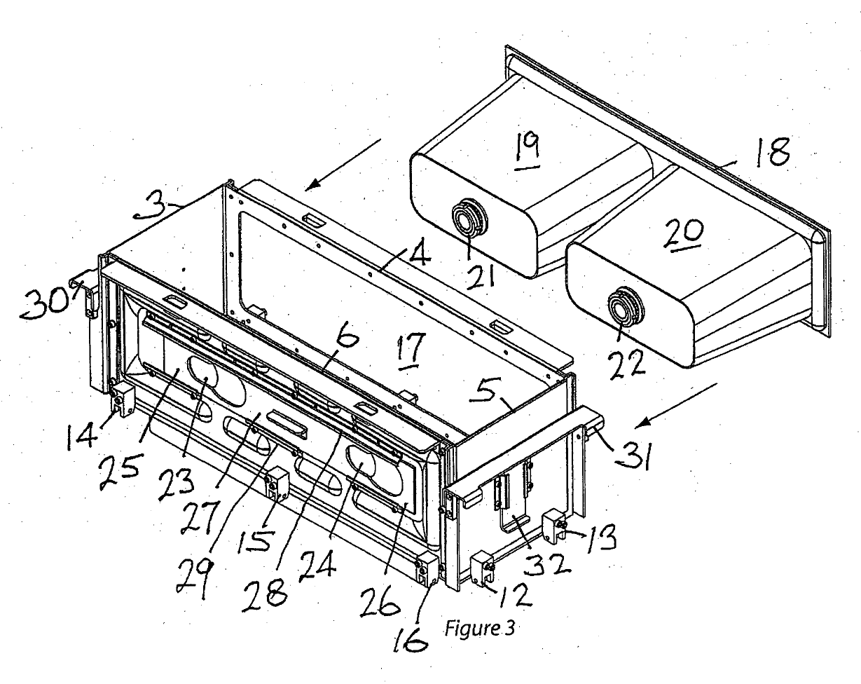

FIG. 4 is a view in perspective of the same embodiment as in the last three illustrations in this case showing the core or plug in a fully inserted position and being held with an interlocking arrangement in such position,

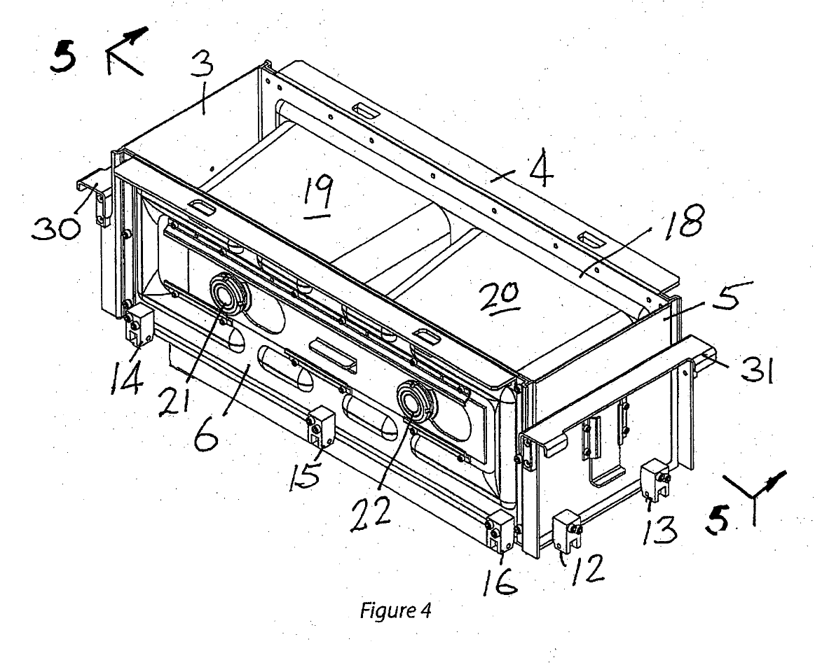

FIG. 5 is a cross sectional view through the view of FIG. 4 including however a first slurry layer with heaped material in the centre of the base,

FIG. 6 is a cross sectional view along the lines 6/6 in FIG. 5,

FIG. 7 illustrates a commencement of pouring of core material into the mould,

FIG. 8 illustrates the way in which the core material will have evened out the bottom layer and is settled to be just below outer edges of the side walls defining the moulding shape,

FIG. 9 illustrates a filling of a top layer, and

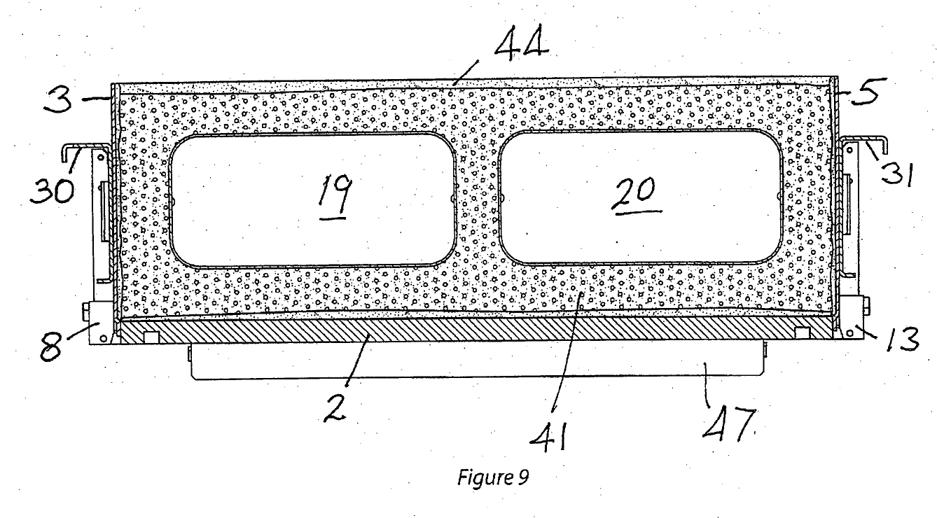

FIG. 10 illustrates a commencement of mould stripping which includes as a first step removal of the inner core or plug.

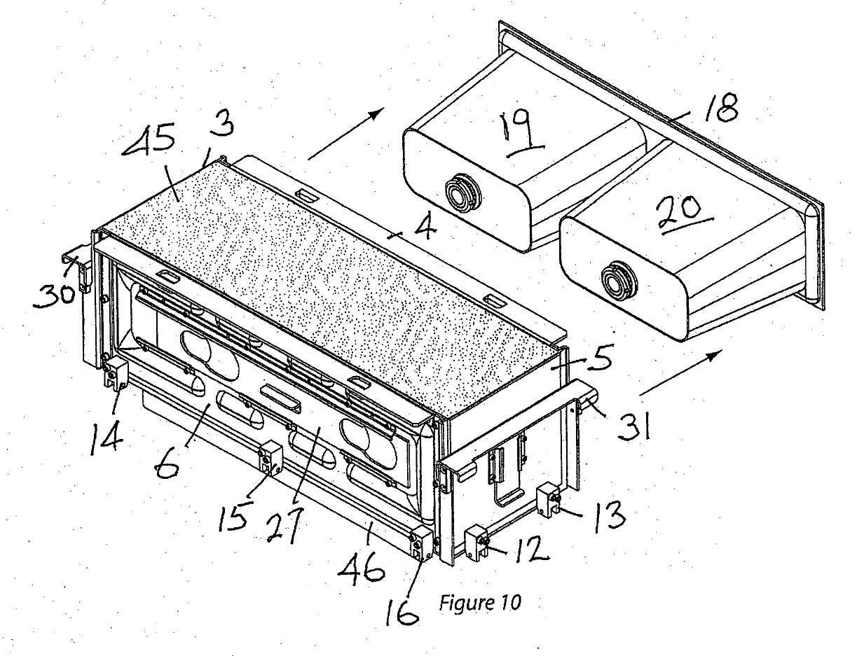

### DETAILED DESCRIPTION OF THE INVENTION AND EMBODIMENTS

The issue being dealt with is that a block is to be wet cast using a gravity casting which means that it will be allowed to set and sufficiently cured to be able to be removed while in the mould or in other words does not assume a seat supporting shape until set within the mould. A block has upper and lower interlocking shapes, the block having a core material and an outer surface layer because of the selection of the nature of the inner core material, it incorporates in this case a hollow interior and it is a function that in order to make moulding of such a lock economically feasible, this should be able to be moulded in a way that facilitates automation in the manufacturing techniques.

A further issue has been that the mould despite its complications, because it will be required to maintain the shape of a block during its setting period, will to therefore need to be replicated many times and therefore the complication in design of the mould itself is an issue in terms of maintaining lower costs.

This embodiment therefore has a base 1 which is a solid substantial member of steel having rectangular sides defining a perimeter and an upper surface 2 which is planar.

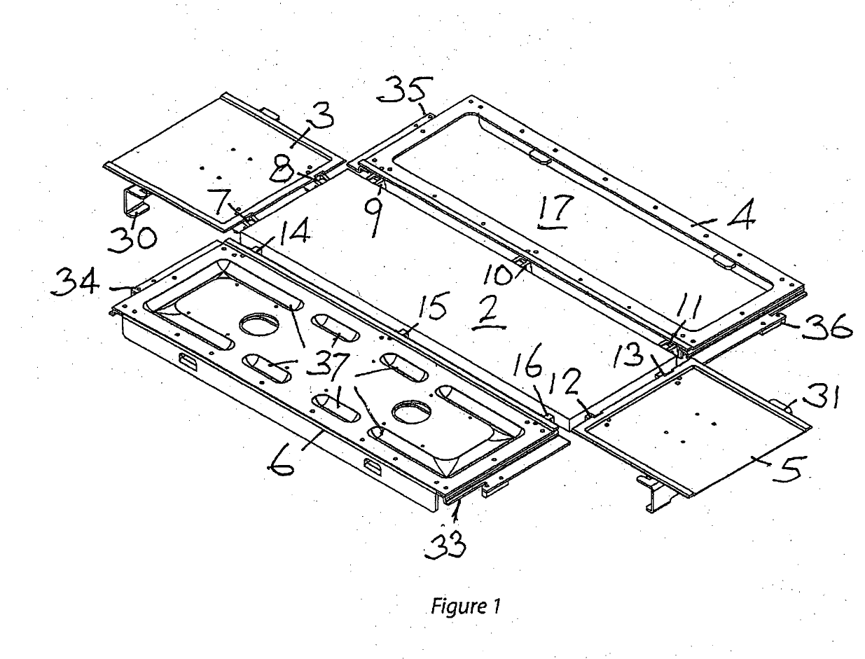

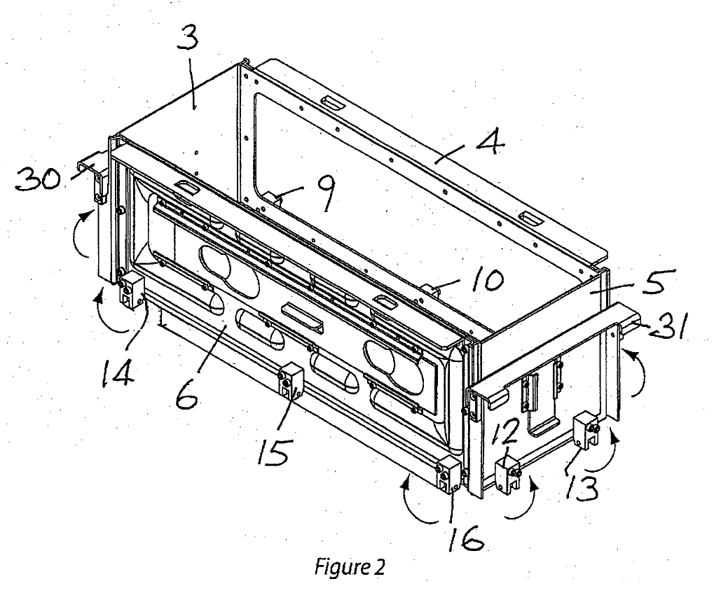

There are four side walls, 3, 4, 5 and 6 each of which have been pressed from sheet steel and each of which is secured to a respective side of the base 1 by brackets so that they can pivotally swing from the mould release position shown in FIG. 1 to the mould defining position as in FIG. 2.

These brackets are shown for side wall 3 at 7 and 8.

For side wall 4, there are 3 sets of brackets shown at 9, 10 and 11.

For side wall 5, the brackets are shown at 12 and 13.

For side wall 6, the brackets are shown at 14, 15 and 16.

In each case, these allow for the respective side wall to pivot about an axis parallel to the respective side to which they are attached.

Side wall 4 includes a central aperture 17 through which a bifurcate core 18 will pass.

The core or plug 18 has two core or plug portions or parts 19 and 20 each of which are a tapered shape and which have an outer end at 21 in one case and 22 at the other which pass through respectively apertures 23 and 24 and these are interlockingly positioned by slide 25 in one case and 26 in the other where these are combined as a single slide plate 27 which are held by slides 28.

The side walls 3 and 5 each have a slide plate 30 in one case and 31 in the other which is held by slides typically shown at 32 these being aligned so as to intersect with slot 33 and 34 on one side and 35 and 36 on the other side so that when the side walls 3, 4, 5 and 6 are in the erected position which is to say the mould defining position that locations are able to be maintained by these interlocking members.

One of the side walls 6 further has a series of depressions shown typically at 37 which provide for casting of arcuately shaped protrusions in an eventual upper surface of a block.

The method of using the mould is that it is first configured as in FIG. 1 where it is adapted to be cleaned and of course by reason of the pivotal connections, the side walls 3, 4, 5 and 6 have their mould defining outer surfaces upper most and the base has it's upper surface available. In this configuration, with the upper surfaces being substantially coplanar this makes it appropriate to effect a cleaning of these surfaces. In one case this is a jet, of high pressure hot water directed to extend as a narrow jet sweeping over all of the uppermost now exposed area of the eventually external surfaces defining outer surfaces of block from the mould. Some difficulty has been experienced in ensuring that debris is consistently cleaned and especially subsequently removing the resultant water on the mould before a next coating of a release agent is to be applied. In one case then the surface is swept with a narrow high velocity jet of water which is expressed to exit at from 10-20 feet/sec. A subsequent step is drying air or in another case the surfaces which have been directly facing the moulded block being located upper most can be brushed with a rotating brush.

From this configuration however it is then changed to be as shown in FIG. 2 where the side walls 3, 4, 5 and 6 are Interlocked together and together with the base 2 to define a mould shape in other words they then assume a mould defining position.

In this embodiment, the method then includes the steps of coating the inside mould defining surfaces which are respectively the inner sides of the side walls 3, 4, 5 and 6 and the upper surface of the base 2 with a release agent in accordance with known techniques which in this case is sprayed onto the surfaces.

The next stage is to coat the inner surfaces of the mould defining shape on selected surfaces with a cement slurry which comprises essentially of Portland cement, sand and sufficient water for malleable hand application purposes.

This is now effected and may be accomplished by a spray head being appropriately positioned and spraying the surfaces. This spray head can be caused to travel in accord with a predetermined program and such that it will be caused while the spray output is constant to be slower across one area rather than another and in this way heap some of the layer material immediately beneath the bifurcate gap in the core or plug.

Such a step is then used to coat each of the selected surfaces which may or may not be applied to all of the surfaces, depending upon the application for which a block to be cast might be used.

Conventionally however the inner surfaces of sidewalls 3, 5 and 6 and the base 2 would be coated with a layer that would approximate 2-3 millimetres in depth. This however is modified to the extent that the slurry is built up so that it is initially 10-15 millimetres in thickness in the approximate location midway between the ends on the base 2 in the manner disclosed.

This build up is to allow for the action of subsequent core material to carry with it some of the layer slurry in it's filling process but help to ensure that a sufficient thickness will eventually be caused and being relatively uniform of the layer material base 2.

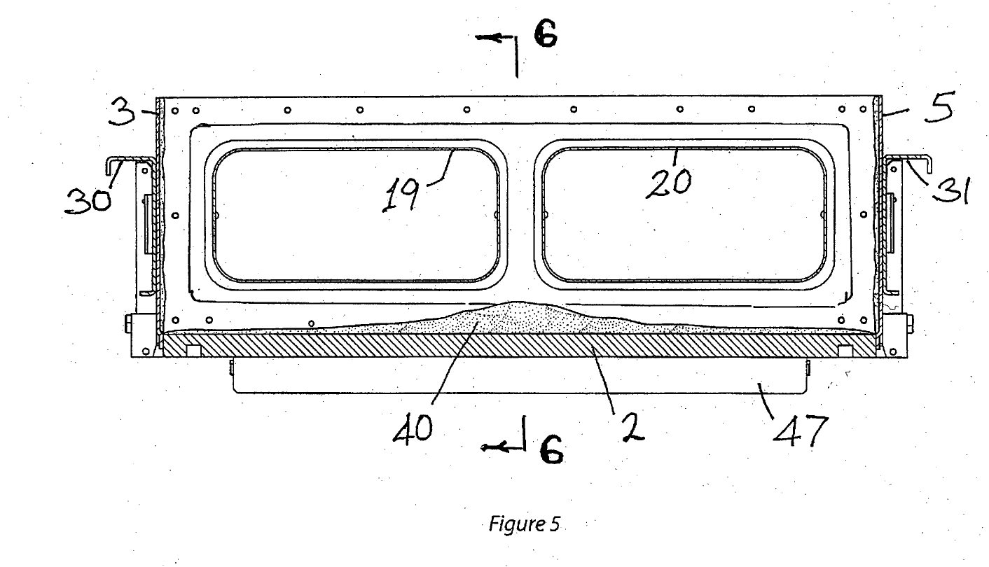

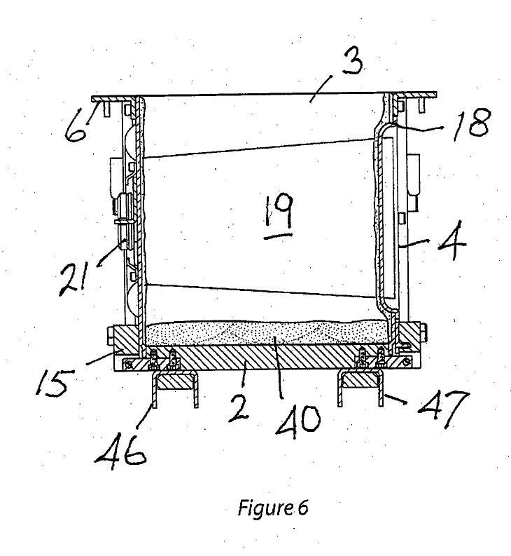

This is shown at 40 in FIGS. 5 and 6 in particular.

These figures do show the cores 19 and 20 in position but it is acknowledged that the layer would be located at least across the base and the respective inner surfaces of the side walls 3, 5 and 6 prior to the insertion of the core or plugs 19 and 20.

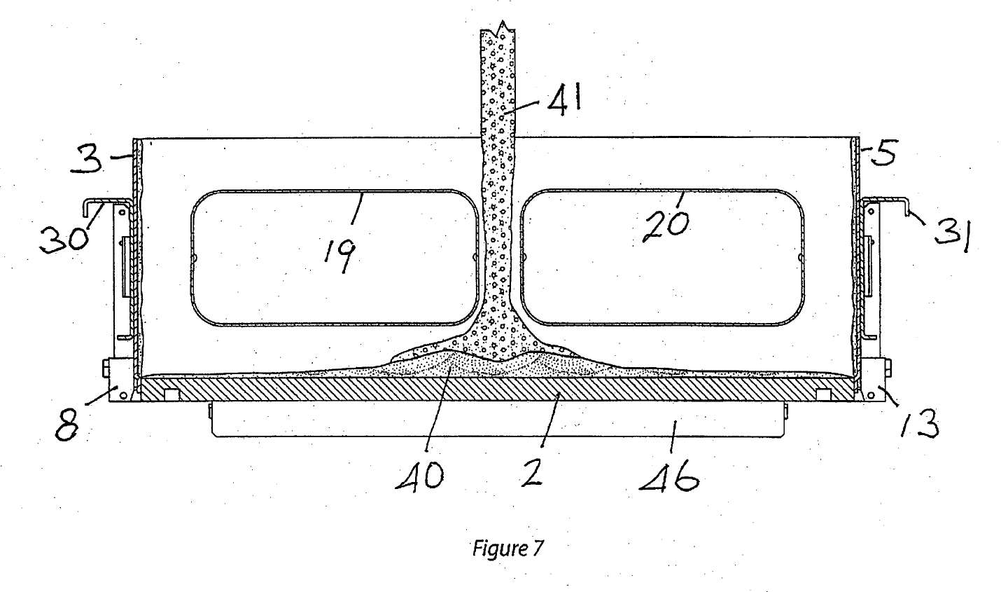

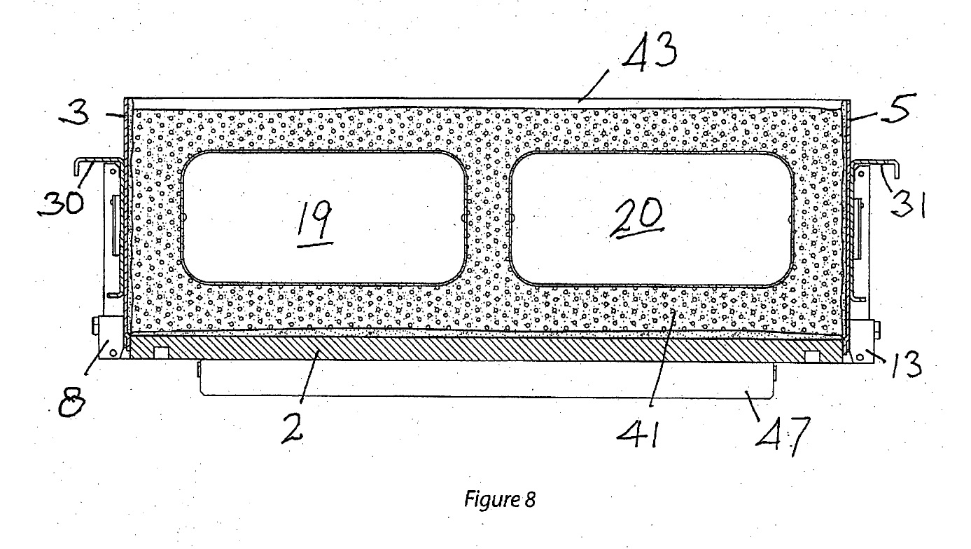

The next step in the method is to fill the mould with core material which is shown at 41 in FIG. 7 and such filling will continue until the status as shown in FIG. 8 is reached which leaves however a fill level which in one case is slightly below the outer perimeter edges of the respective side walls 3, 4, 5 and 6.

This is shown in. FIG. 8 at 43.

This is then topped up with a slurry layer shown at 44 the upper surface of which is then floated off so as to leave an appropriate level surface leaving however a defining layer as an external surface of a completed block.

In order to maintain this material tam intrusion from lighter expanded foam beads or the like, while in a preset status it has been found that the material for providing the layer 44 is chosen so that it will have a lesser density than the Portland cement and sand portion of the core material.

This is achieved in this particular case by using Portland cement and replacing sand with scoria. By using selected scoria, derived from basaltic lava, it has been found that this provides a somewhat lesser density of the components that then facilitate the layer 44 staying more or less above the core material 41 and without unwanted intrusions.

Once the mould has been filled as described, it is then left to set and cure to an extent that the moulded product can then be removed from the mould for stacking and storage outside of the mould although the cement is expected to continue to cure as is traditional with Portland cement for some many days thereafter. Subsequently, the cores 19 and 20 are extracted, the side walls 3, 4, 5 and 6 released from the interlocking engagement and the side walls are then pulled apart to leave a block 45 which can then be separately packed, removed from being supported by the base 2 and as desired, independently further allowed to be further cured further to being distributed or used.

While we have described one technique for achieving an external layer it is also possible to achieve a differential layer by vibrating the filled mould where the slurry then will concentrate at the surfaces. This vibration is applied externally so that it is the mould itself that is vibrated and this is proceeded with by vibration in a range of from 2-10 vibrations per second and is effected by a vibrating source lifting and lowering the mould. In practise this is varied depending on the extent of layer depth and consistency looked for which can be determined on a case by case basisi.

The moulded product is left in the mould for a period of between several hours and 10 hours although with accelerant a period of approximately four hours is found to be sufficient. While reference is made to the cement eg Portland cement being cured it is understood that curing continues after extraction from the mould.

The mould itself is adapted to be used in automatic handling machinery to make it economic and to this extent includes slides 46 and 47.

The mould by reason of its features is adapted now to be directed to a cleaning station where with each of its side walls in a mould release position, each of the surfaces that are moulded product shape defining surfaces are now able to be positioned uppermost and are generally aligned to be across a approximately common plane with the base and side walls being supported on a flat supporting surface.

This facilitates cleaning of the surfaces. In a first method this cleaning includes a jet of water that is directed to track across the surfaces sequentially. The extent of pressure and the volume of water will vary with the test simply being that it is sufficient to effect removal of residual masonry material. In the event that the water is not sufficient, physically brushing can be used and in the case that the brushing is needed it is possible to reduce or even not use water at all. This may speed the subsequent treatment steps of the mould including removing a drying step.

Subsequent to this then the mould, where water has been used, is directed to a drying station where hot dry air is directed over the surface and is continued for a sufficient time to remove any residual water.

The mould still in its mould release status is then directed to a further station where a release material such as a vegetable oil is sprayed onto the uppermost surfaces and thereafter the mould is directed to s reassembly station.

The core is tapered for ease of removal and is found not to have so much residual material adhering to the surfaces. However, a customized brushing of any detected adhering material is found usually to be sufficient prior to a further application to the contact surfaces of a release agent.

The manufacture using a wet cast process with Portland cement based masonry materials of blocks requires that such a process can be achieved in a way that allows for economic processing.

1. A method of manufacture of a wet cast block using a mould and gravity casting, the mould having a base with a rectangular perimeter, and four side walls, each side wall secured to a respective end or side of the perimeter of the base so that each side wall can, in one case, be positioned in a moulding position where each side wall is held together with the other side walls to define, with the base, a moulding shape with an uppermost open top, and in a further position, be in a block or brick release position, where each respective side wall is swung outwardly from the moulding position, the method of manufacture including the steps of
positioning the side walls in a mould defining position,
filling the mould with a to be cast wet cement material,
allowing the said material to set and cure,
then changing the relative position of the respective side walls to a mould release position and thereafter removing the moulded block therefrom.

2. The method of manufacture as in claim 1, where one of the side walls has an aperture therethrough, a core adapted to be positioned within the mould and to be removably positioned therein by passing through the aperture in the side wall and being supported therein by the side wall, the method of manufacture including the steps of inserting the core through the side wall aperture when in a mould defining position, and removing the core by extraction through the aperture when the said material forming the block has set and cured and before changing the relative position of the side walls.

3. The method of manufacture as in claim 1, in which the core is bifurcate and is positioned when in a mould with a first side supported by a first side wall and each of second ends are supported by a further side wall which is that side wall opposite to the said first side wall.

4. The method as in claim 1, wherein each of the respective side walls is each secured to the base by being hingedly coupled thereto.

5. The method as in claim 1, including the steps of inserting through one of the side walls, a core after the side walls are located in a mould defining position, holding the core between a first side wall and an oppositely positioned second side wall, then removing the core by extracting this from being secured to the respective side walls after the material has set and cured and only thereafter moving the side walls to a mould release position and effecting removal of the moulded block.

6. The method as in claim 1, including the further steps of directing the mould to a cleaning station where its side walls and base are positioned in a mould release position and provide, as an uppermost surface, those faces that define the moulded shape, and there is effected a cleaning by brushing there across.

7. The method as in claim 1, wherein there is effected a vibration of the mould once filled and before setting or curing of the mortar.

8. A method of manufacture of a block having at least one face layer which is of higher density than most of the material from which the block is made, the mould having a rectangular base, and four side walls, each side wall secured to a respective end or side of the base so that each can, in one case, be positioned in a moulding position where each side wall is held together with other side walls defining, with the base, a moulding shape, and in a further position, being in a moulded block release position each respective side wall being swung outwardly from the moulding position, the method of manufacture including the steps of
positioning the side walls and base in a mould defining position,
inserting through one of the side walls, a core which is either one member being bifurcate providing a gap midway between the respective core portions or there are two separate cores which leaves a gap in the mould therebetween, which core or cores is or are positioned after the side walls are located in a mould defining position and is or are held between a first side wall and an oppositely positioned second side wall,
filling the mould with a to be cast wet cement material,
allowing the said material to set, and cure,
removing the core or cores by extracting it or them from a side wall after the material has set and cured,
then changing the relative position of the respective side walls to a mould release position and thereafter removing the moulded block therefrom.

9. The method as in claim 8, wherein the material to be cast includes Portland cement and foamed polystyrene plastics beads.

10-11. (canceled)

12. The method of manufacture as in claim 8, including the steps of applying a first layer to at least some of the side walls and/or the base inner surfaces of a mould as above identified prior to introduction of the core material.

13. (canceled)

14. The method of manufacture as in claim 12, where a thicker layer in the vicinity of the mould where core material is subsequently to be introduced is initially located.

15. The method of manufacture as in claim 8, where a top layer is made of a material where the density is less than any immediately underlying wet matrix.

16. (canceled)

17. A block resulting from the method according to claim 1.

18. A block resulting from the method according to claim 8.
